(19) United States
(12) Patent Application Publication
(10) Pub. No.: US 2022/0324501 A1
(43) Pub. Date: Oct. 13, 2022

(54) PERSONAL HAULING DEVICE THAT CONVERTS INTO A CHAIR

(71) Applicant: Ryon Brown, Leander, TX (US)

(72) Inventor: Ryon Brown, Leander, TX (US)

(21) Appl. No.: 17/717,948

(22) Filed: Apr. 11, 2022

Related U.S. Application Data
(60) Provisional application No. 63/173,287, filed on Apr. 9, 2021.

(51) Int. Cl. B62B 5/08; B62B 1/00; B62B 1/20; B62B 1/22; A47C 13/00

(52) U.S. Cl. CPC B62B 5/085; B62B 1/008; B62B 1/208; B62B 1/22; A47C 13/00; B62B 2206/006

(57) ABSTRACT

Hauling devices are adapted to facilitate carrying objects in a cart mode and seating in a chair mode. Other aspects, embodiments, and features are also included.

### PRIORITY CLAIM

This application claims priority to and the benefit of provisional patent application No. 63/173,287 filed in the U.S. Patent and Trademark office on Apr. 9, 2021, the entire content of which is incorporated herein by reference as if fully set forth below in its entirety and for all applicable purposes.

### TECHNICAL FIELD

The technology discussed below relates generally to outdoor equipment, and more specifically to personal hauling devices convertible into a chair.

### BACKGROUND

With regard to outdoor activities (camping, fishing, music festivals, sporting events, expeditions, outdoor field work, etc.), it is typical for many participants to carry some amount of equipment or gear. Often, much of that gear must be carried by hand. Additionally, many outdoor activities involve participants sitting once they have arrived at their destination. As a result, some type of folding or collapsing chair is often among the equipment or gear that is carried by a participant. Accordingly, carts capable of carrying equipment or gear, and also operating as a chair would be beneficial.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure include personal hauling devices that are capable of use in a cart mode and a chair mode.

Other aspects, features, and embodiments associated with the present disclosure will become apparent to those of ordinary skill in the art upon reviewing the following description in conjunction with the accompanying figures.

### DRAWINGS

FIG. 1 includes various views of the hauling device of the present disclosure in its primary four modes of use, including a loading mode (FIG. 1A), a hauling mode (FIG. 1B), a chair mode (FIG. 1C), and a storage/transportation mode (FIG. 1D).

FIG. 2 includes various views of the hauling device according to at least one example.

FIG. 3 includes various views of the hauling device in a chair mode according to at least one example.

FIG. 4 includes various side views depicting conversion between a storage mode, a loading mode, a hauling mode, and a chair mode according to at least one example.

FIG. 5 includes side views of the hauling device in a storage/transportation mode according to at least one example.

FIG. 6 includes various views depicting a load foot according to at least one example.

FIG. 7 includes side views of the hauling device in a chair mode according to at least one example.

FIG. 8 includes various views of a hinge according to at least one example of the present disclosure.

FIG. 9 includes various views of a secondary hinge according to at least one example of the present disclosure.

FIG. 10 includes various views of the hauling device according to at least one example of the present disclosure.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The illustrations presented herein are, in some instances, not actual views of any particular hauling device or hauling device components, but are merely idealized representations, which are employed to describe various features associated with one or more embodiments of the present disclosure. Additionally, elements common between figures may retain the same numerical designation.

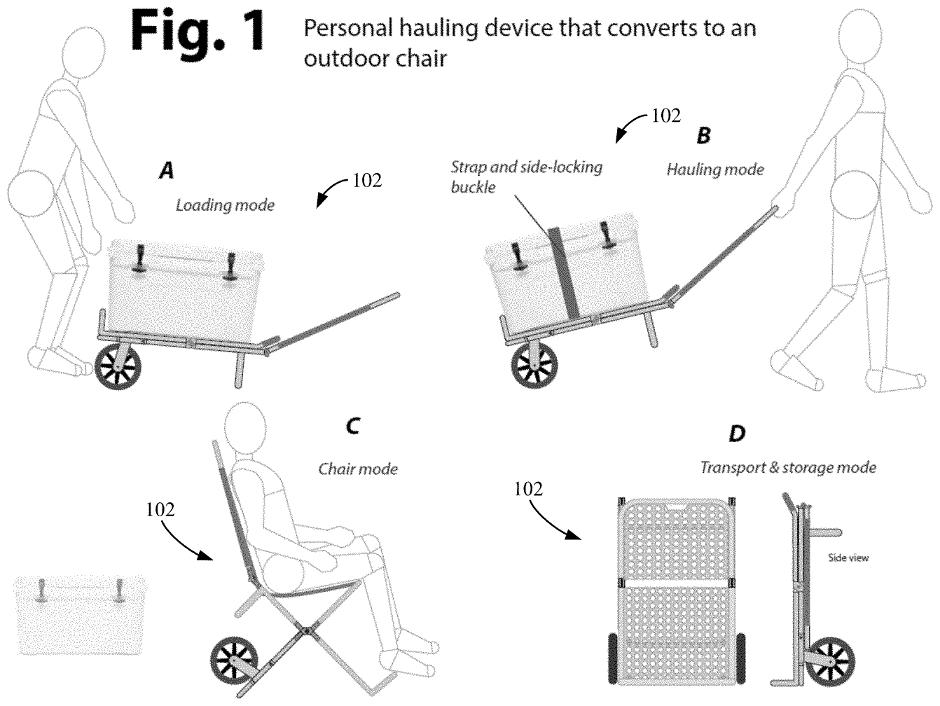

Referring to FIG. 1, various views of the hauling device 102 of the present disclosure are depicted in its primary four modes of use. As shown, the hauling device 102 may operate in a loading mode shown in FIG. 1A. A cooler is shown as an example of an item that may be loaded onto the hauling device 102 of the present disclosure, although it will be apparent that any suitable item or items may be positioned on the hauling device 102. FIG. 1B shows the hauling device 102 being operated in the hauling mode. As shown, an adjustable strap with locking buckle may be employed to keep loads secure. Additional options may include a cargo net or other load-securing hardware. As shown in FIG. 1C, the hauling device 102 can be converted to a chair mode, enabling a person to sit. Conversion from hauling mode to a chair is as simple as grasping the outer portion of the seat and pulling the product open until the hinges engage at full 90° open. FIG. 1D shows the hauling device 102 in a storage or transport mode. In this mode, the hauling device 102 can be easily stored or transported without taking up much space.

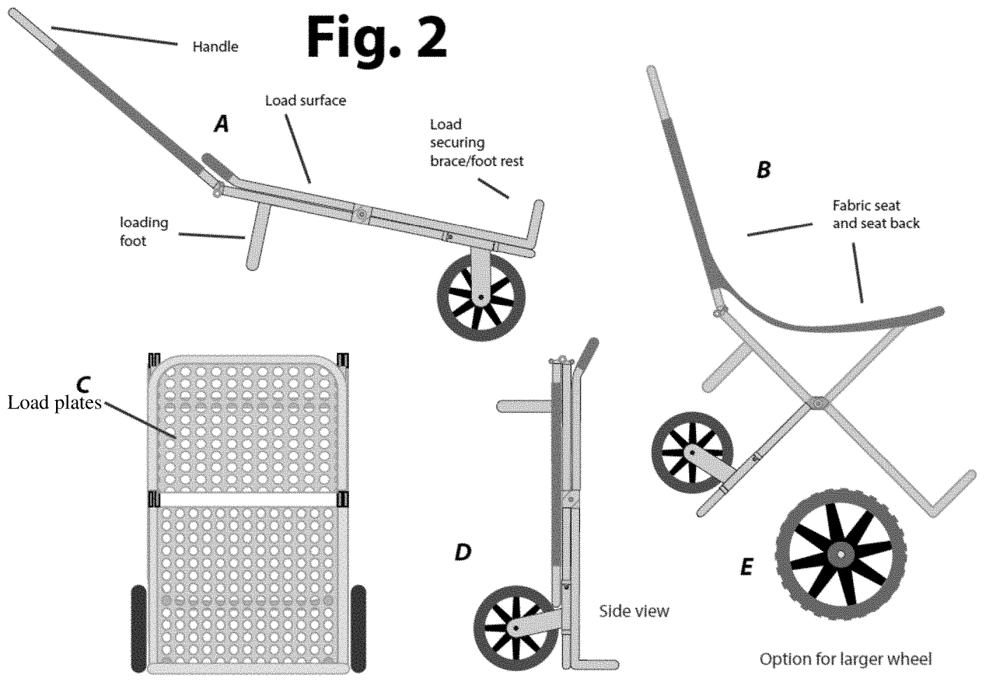

As shown in FIG. 2, the hauling device 102 may include various components. For example, as shown in FIG. 2A, the hauling device 102 may include a handle, a load surface, a load securing brace or foot rest, a loading foot. As shown in FIG. 2B, a fabric seat and seat back are included. Load plates may be included, as shown in FIG. 2C. The load plates may distribute weight and provide a flat surface upon which loaded items can be stacked and secured. The load surface also accommodates a variety of removable attachments, accessories, or containers such as a child's safety seat or a folding box. Additionally, a standard 8″ wheel or the option for a larger, 15″ wheel with outdoor tread are shown in FIG. 2E. Wheels may be removable by the user.

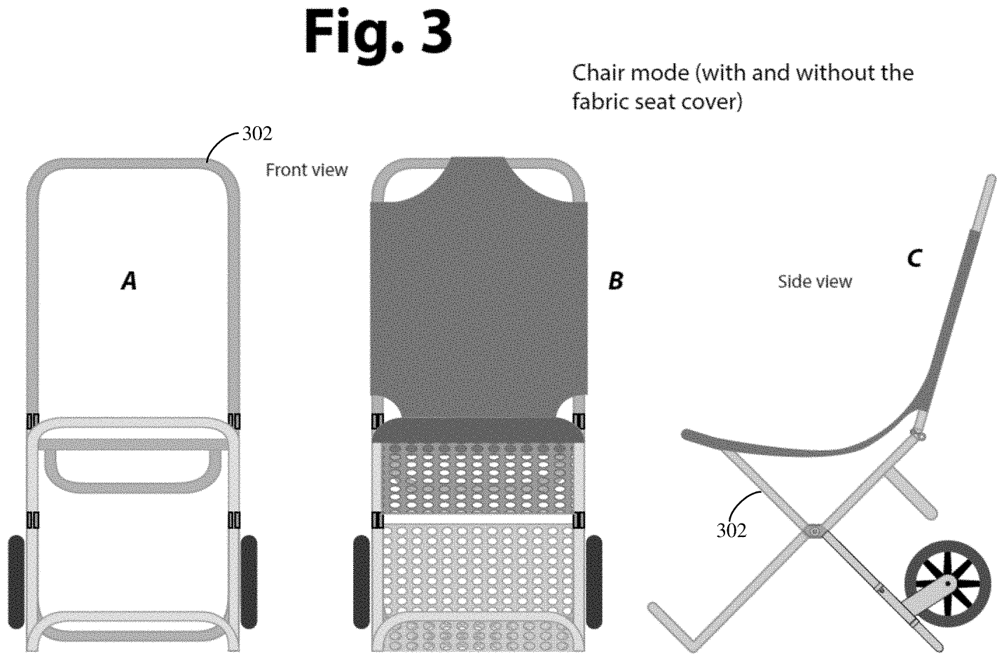

FIG. 3 includes various views of the hauling device 102 in a chair mode. As shown, the hauling device 102 includes a frame 302. The frame can be formed of any suitable material. In at least one example, the frame 302 includes round aluminum tube. Other materials are possible. The curved portions can be bent in a tube bender. This allows the seat fabric to be removed by sliding it off the frame once connective nuts and bolts are removed. The fabric seat and backrest cover may be configured to display messaging, logos, advertisements, or other branding.

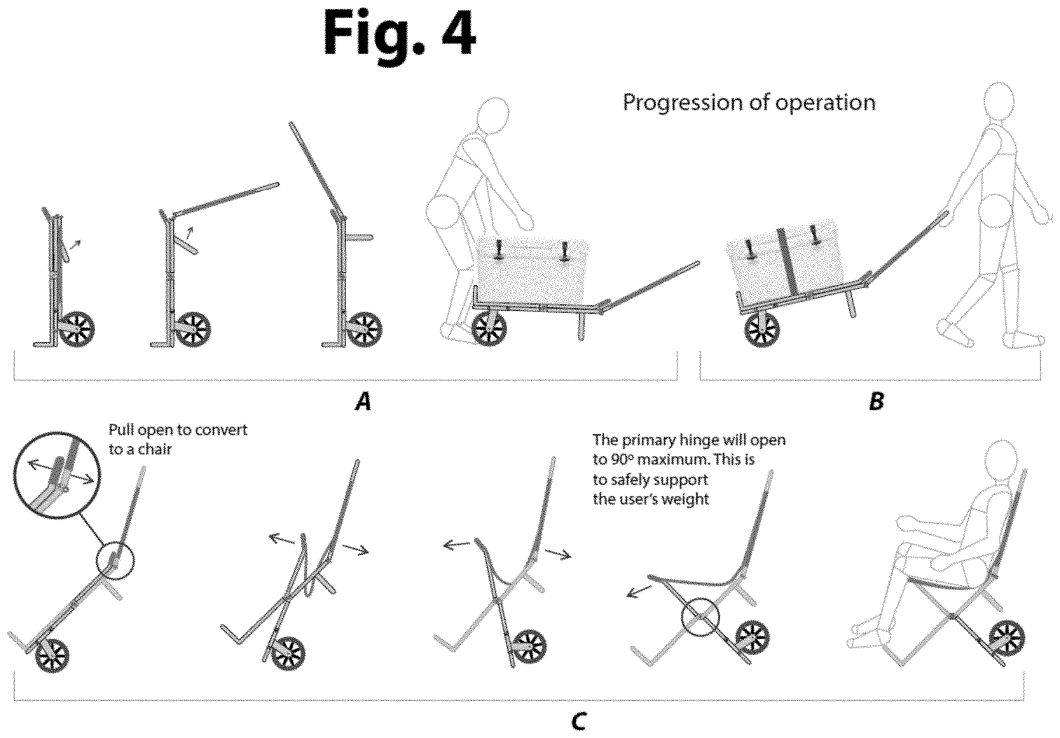

FIG. 4 illustrates a progression of converting the hauling device 102 between different modes of operation. As shown, progression A illustrates conversion of the hauling device 102 from the storage mode to the loading mode by unfolding the handle and rotating the hauling device to rest on the wheels and the loading foot. FIG. 4B shows the user pulling the hauling device by the handle with a load secured thereto. A shown in FIG. 4C, the hauling device is further converted from the hauling mode to the chair mode by adjusting the frame about a primary hinge to form the legs of the chair.

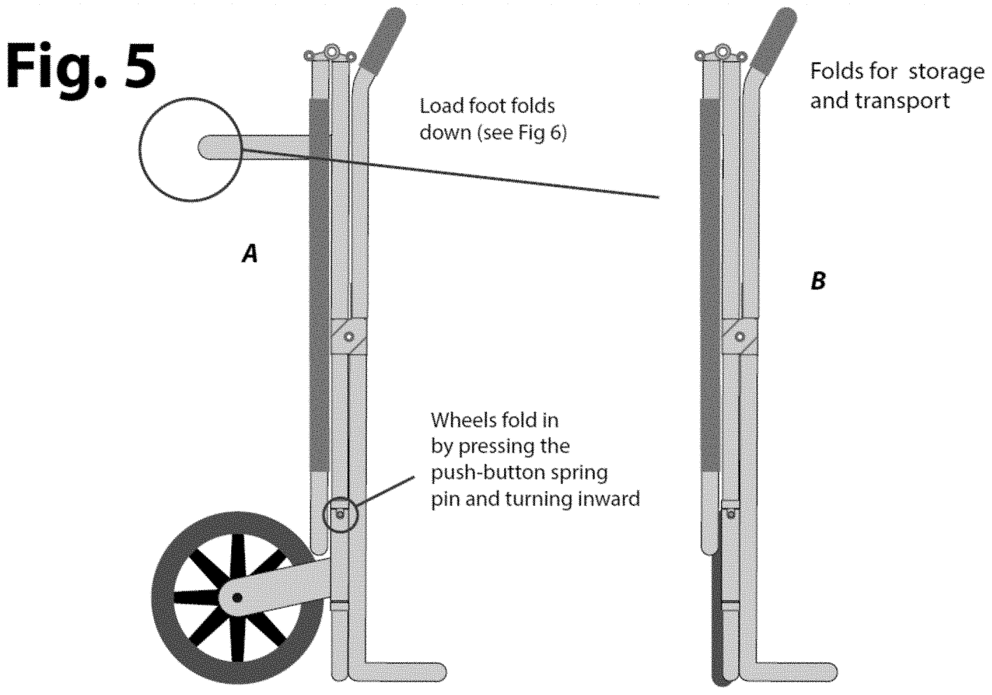

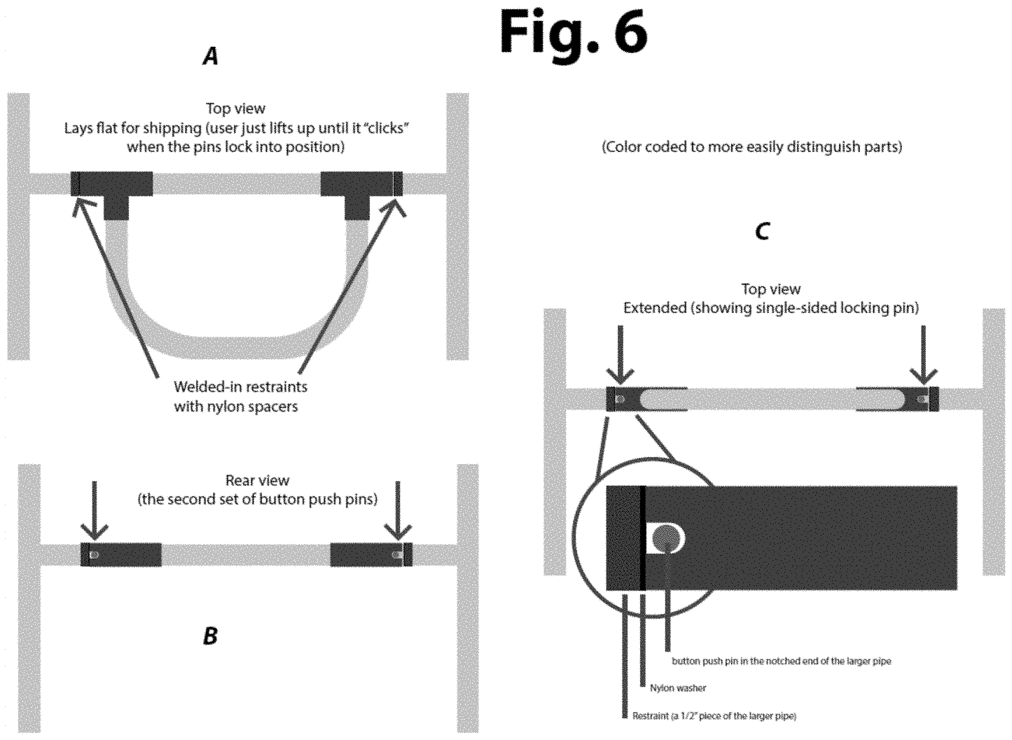

FIG. 5 are side views of the hauling device 102. As shown, when converting to the storage mode, the load foot can fold down, and the wheels can fold in. As a result, the hauling device 102 can be relatively flat and easily stored or transported without taking up much space. FIG. 6 illustrates additional features associated with the load foot. As shown, the load foot can include locking push pins or other hardware to facilitate folding in the load foot.

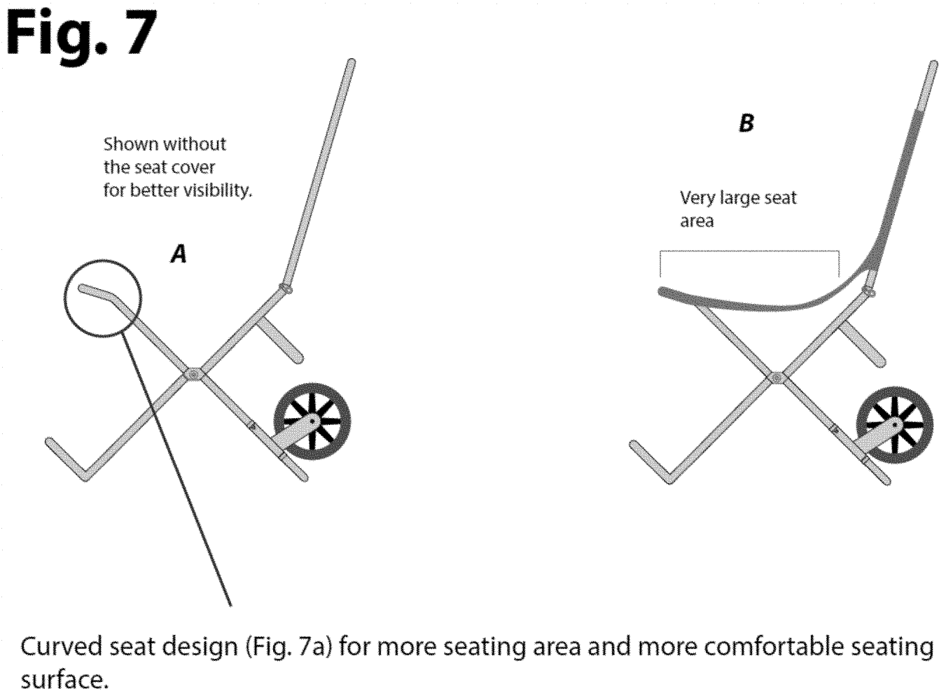

FIG. 7 includes side views of the hauling device 102 in chair mode. As shown, the frame 302 can include a curved seat design. A large portion of the seat cover fabric can be suspended between two attachment points on the frame. This gives the seat a hammock-type feel. Uniquely, the seat cover may be capable of being removed by the user for laundering or replacement.

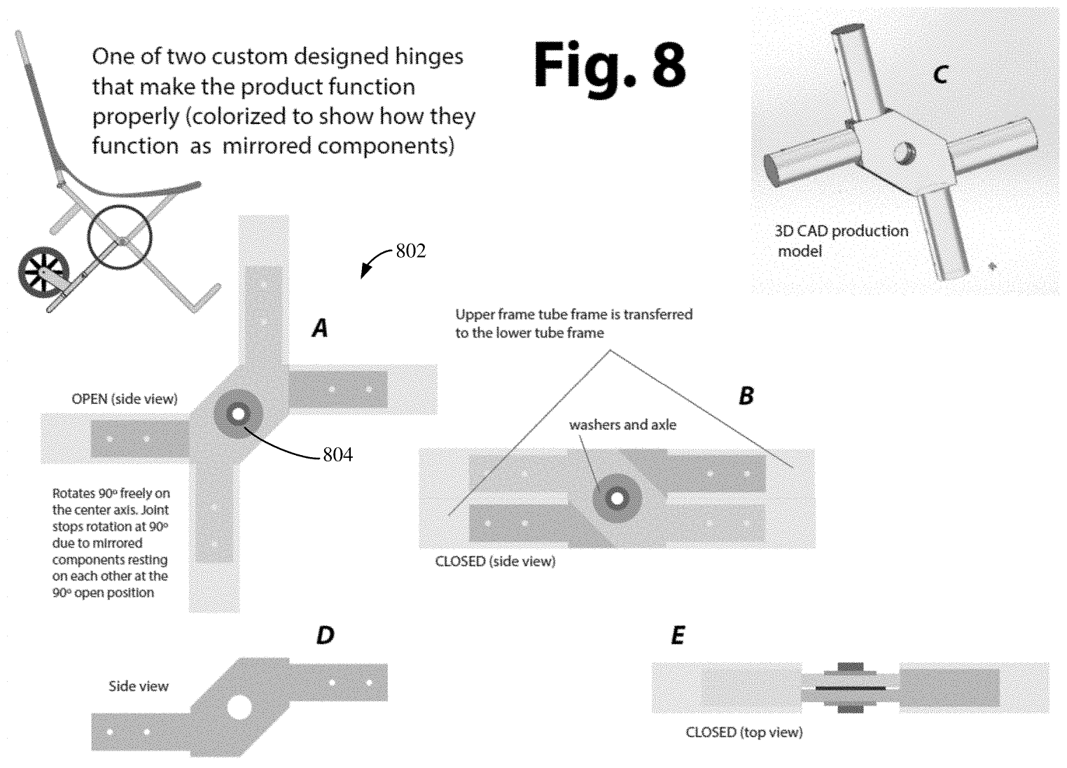

FIG. 8 includes various views of the primary hinge, according to at least one embodiment. As shown, the primary hinge 802 is the hinge coupling the chair leg portions of the frame. This original hinge design is what makes the product fold up and lay flat in hauling mode and unfold in chair mode without the use of pins, latches, or other hardware. The hinge 802 facilitates rotation of each leg freely on the center axis 804. The hinge 802 includes an angled mid-section for each leg, and this angled mid-section results in the mirrored components resting on each other at the open position, which in this example may be about 90°.

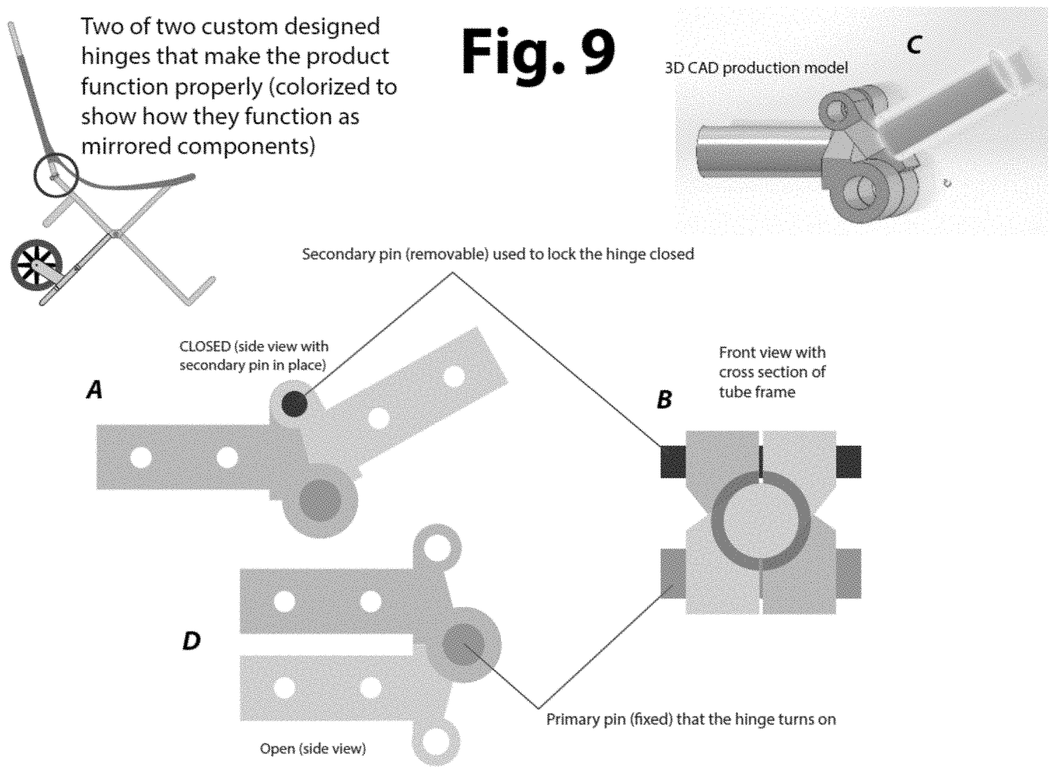

FIG. 9 includes various views of a secondary hinge that may be found between the chair legs and the seat back. As shown, the secondary hinge may utilize a locking mechanism, such as a pin to lock the hinge in the closed position. This original hinge design connects the load surface to the handle and allows the handle to also be folded up, making the product smaller for easy handling when taking it in and out of a vehicle, or a storage location, such as a garage.

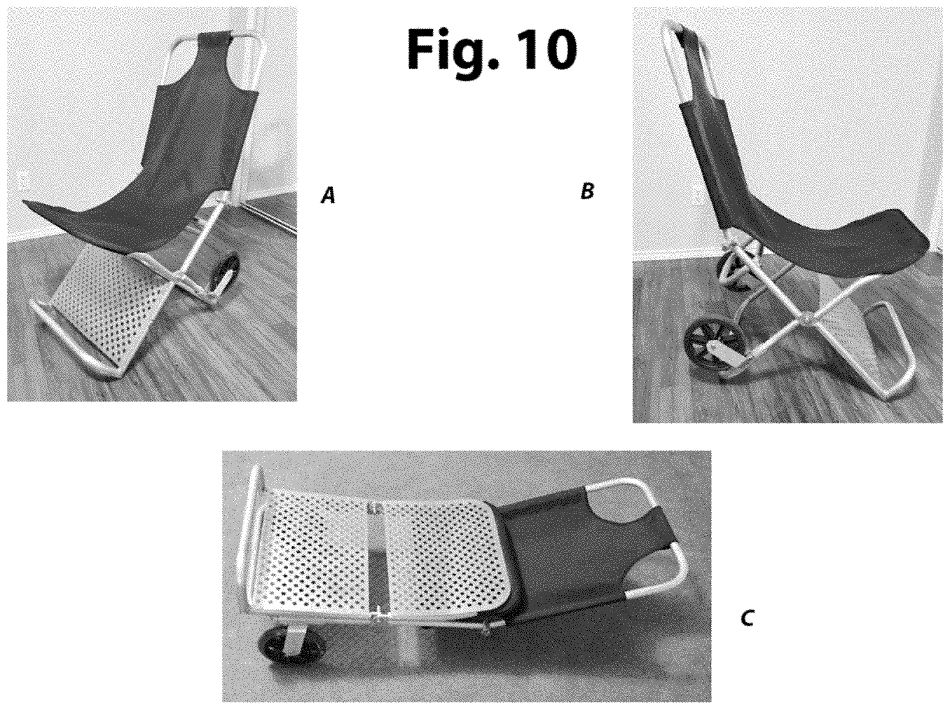

FIG. 10 are various isometric views of a hauling device 102 according to at least one example of the present disclosure.

Additional aspects of the disclosure include methods of making hauling devices 102 including one or more of the features disclosed herein, and methods of transitioning a hauling device between the different modes, such as in the examples shown in FIG. 4.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A hauling device, comprising one or more aspects described herein and/or shown in the accompanying figures.

2. A hauling device, comprising features facilitating conversion between a storage mode, a loading mode, a hauling mode and/or a chair mode.
